(19) United States
(12) Patent Application Publication
(10) Pub. No.: US 2005/0141095 A1
(43) Pub. Date: Jun. 30, 2005

(54) Reflecting sheet

(76) Inventor: Youngtack Shim, Port Moody (CA)

Correspondence Address: Youngtack shim, 155 Aspenwood drive, Port Moody, BC, V3H 5A5, CA

(21) Appl. No.: 10/745,554

(22) Filed: Dec. 29, 2003

(51) Int. Cl. G02B 5/04

(52) U.S. Cl. 359/615; 359/613

(57) ABSTRACT

The present invention generally relates to an optically active sheet for deterring reproduction of an image provided therein. The optically active sheet generally consists of a layer of a plain sheet and another layer of an optically active agent. The plain sheet is provided with the image and capable of emanating light rays representing the image. The optically active agent is attached onto the plain sheet, and is arranged to distort the paths of light rays projected thereon. Accordingly, the optically active sheet is capable of distorting the paths of the light rays representing the image, thereby emanating light rays representing an distorted image.

This application claims a benefit of a Disclosure Document No. 503,108, entitled “Reflecting Sheet” filed on Jan. 3, 2002, an entire portion of which is incorporated herein by reference.

### BACKGROUND OF THE INVENTION

With the advent of optical technology and supporting hardware therefor, many devices have become available for reproducing an image of a document. For example, various types of photo-copying machines have been in use for more than 20 years. The recent models are equipped with sophisticated micro-processors capable of performing assorted editing options so that they can perform intelligent tasks suited for, e.g., desk-top printing. In addition, scanning devices have also been in wide use to scan, digitize or reproduce the image of the document. In particular, the digitized image may be easily manipulated and/or altered thereafter by a conventional image acquisition or processing software. Accordingly, it is virtually at the finger-tip of an operator to reproduce any images of interest.

Despite all the benefits provided by the conventional image reproduction devices, there is always a danger that the document may be reproduced, altered or forged by an unauthorized person for illegal purposes. Sensitive information provided on a document may be reproduced by an intruder, if provided with a photo-copy machine and enough time. In addition, portable scanners which have been recently introduced to the market are small enough to fit in a pocket, and may store thousands of pages of information in a memory chip. Accordingly, given the opportunity, a perpetrator can scan any sensitive documents at will. Furthermore, an image processing software may facilitate alteration or manipulation of the scanned image of the document so that a forged document may be used for illegal purposes.

The anti-reproduction measures, however, have not been catching up with recent development in the reproduction technology. Accordingly, to fend off the unauthorized reproduction of the document, a proprietor does not have a lot of options. He can keep the sensitive document in a safe place or must provide a special security system thereto. However, when certain documents have to be distributed to a limited number of people, it is very difficult, if not impossible, to prevent leakage of information provided thereon. For example, when the trade secrets should be produced to an adverse party during a discovery process of a litigation, it is virtually impossible to ensure that the adverse party will not reproduce the documents for other uncontemplated purposes and distribute to unauthorized persons. Special paper having an extremely dark crimson shade has been in limited use so that photo-copying or scanning yields virtually black reproduced copy, thereby preventing reproduction thereof. However, the one most important drawback of such paper is that it is very difficult to comprehend the images on such sheet itself, not to mention the reproduced copy or scanned image thereof.

Accordingly, there is a need for a sheet capable of deteriorating quality of a copy or a scanned image thereof, while maintaining readability of the images provided on the sheet. Such sheet will effectively prevent unauthorized reproduction or scanning of the sensitive information provided thereon.

### SUMMARY OF THE INVENTION

The present invention generally relates to an optically active sheet [abbreviated as the “O-A sheet” hereinafter] capable of preventing reproduction of an image provided therein.

In one aspect of the invention, an O-A sheet may be arranged to include a plain sheet onto at least a portion of which an optically active agent [hereinafter referred to as the “O-A agent”] is attached. The plain sheet includes an image provided thereon and is capable of emanating first light rays having a regular distribution pattern that represents the image. The O-A agent is generally arranged to distort paths of light rays projected thereupon and the O-A sheet is capable of emanating second light rays which have a distorted distribution pattern of the image which is different from the regular distribution pattern representing the image.

Embodiments of this aspect of the present invention may include one or more of the following features.

The O-A sheet may be formed by providing a non-peelable bonding between the plain sheet and the O-A agent.

The O-A sheet may be arranged such that the difference between the regular and the distorted distribution pattern of the light rays may depend upon a factor(s) including, but not limited to, a source incident angle of incident light rays emitted by a light source toward the image, a first projection angle of the first light rays emanating from the plain sheet, a second projection angle of the second light rays emanating from the O-A agent or O-A sheet, a first distance between a light source and the image provided on the plain sheet, and a second distance between the image and an image reproduction device. The difference between the distribution patterns may be arranged to reach a maximum value thereof when at least one of the incident and/or projection angles is greater than 30°, 45°, 60°, 75°, 85° or 90° with respect to the plain sheet. Alternatively, the difference between the distribution patterns may also be arranged to reach a maximum value thereof when at least one of the first and second distances is less than 3 feet, 1 foot, 9 inches, 7 inches, 5 inches, 3 inches or one inch.

The O-A sheet may be arranged so that the second light rays emanating therefrom have a distortion ratio less than 1.0, where the distortion ratio is generally defined as the ratio of the second intensity of the second light rays to the first intensity of the first light rays. The first intensity of the first light rays is measured by projecting, upon the image on the plain sheet, the incident light rays emitted from a light source located at the first distance and at the source incident angle with respect to the image and by measuring the amount of the first light rays which emanate from the image and which are projected upon a light collector fixed at a given measurement location. The second intensity of the second light rays is measured by projecting, upon the same image, the same incident light rays emitted from the same light source at the same first distance and at the same source incident angle with respect to the same image and by measuring the amount of the second light rays emanating from the same image in the optical sheet and projected upon the same light collector fixed at the same measurement location. The O-A sheet may be provided such that the distortion ratio is less than 0.9, 0.7, 0.5 or 0.3. The O-A sheet may also be arranged to have a minimum distortion ratio, e.g., 0.1 or 0.01. The O-A sheet may further be arranged to emanate at least a portion of the second light rays at a second projection angle which is different from a first projection angle at which the plain sheet emanates a significant portion of the first light rays.

The O-A agent may have a continuous solid structure such as a sheet, film, screen, mesh, net, string, and/or wire. For example, the O-A agent may have an upper flat surface and a lower non-flat surface or, alternatively, may also have a surface structure such as a protrusion, groove, and/or aperture. Such surface structure may be distributed evenly or unevenly over at least a substantial portion of the O-A agent.

In the alternative, the O-A agent may be arranged to have a non-continuous solid structure such as a bead, flake, shrapnel, rod, cone, cylinder, sphere, hemisphere, powder, and/or particulate. The O-A agent may also have a non-solid structure such as gel, paste, gum, aerosol, spray, and/or solution.

In another aspect of the invention, an O-A sheet may include a plain sheet having an image provided thereon and an O-A agent which is attached onto at least a portion of the plain sheet. The O-A agent may be arranged to distort distribution pattern of light rays which emanate from the plain sheet and represent the image provided thereon. In the alternative, the plain sheet may be arranged to emanate light rays having the light distribution pattern representing the image and the O-A agent may be arranged to distort the distribution pattern of the light rays. In yet another alternative, the plain sheet may be arranged to emanate light rays which have a regular distribution pattern representing the image, and the O-A agent may be arranged to distort at least a portion of the regular distribution pattern and to emanate light rays having a distorted distribution pattern of the image which is different from the regular distribution pattern.

In yet another aspect of the invention, a method is provided to distort an image provided on a plain sheet which is capable of emanating first light rays having a regular distribution pattern representing the image. The distorting method includes the steps of attaching an O-A agent onto at least a portion of the plain sheet to form an O-A sheet, distorting paths of light rays projected toward the image, and emanating second light rays from the O-A sheet so that the second light rays are arranged to have a distorted distribution pattern of the image which is different from the regular distribution pattern representing the image.

Embodiments of this aspect of the present invention may include one or more of the following features.

The method may include the step of deterring reproduction of the image provided in the O-A sheet. In the alternative, the method may include the steps of reproducing at least a portion of the image provided in the O-A sheet by an image reproduction device and obtaining a reproduced image which is distorted and, therefore, different from the image. The reproduction device may include, but not limited to, a camera, movie camera, video camera, copy machine, scanning device, facsimile, CCD (charge-coupled device), OCR (optical character recognition device), acoustic-wave imaging device, and/or any other electromagnetic wave imaging device.

The above deterring step may include the step(s) of utilizing optical properties of the O-A agent and/or the O-A sheet, where such optical properties may include, but not limited to, the reflective, refractive, diffractive and/or transmitting property thereof. The deterring step may also include the step of changing brightness or color of at least a portion of the image into that of a background, changing brightness or color of at least a portion of the background into that of the image, obscuring or altering the difference in brightness or color between the image and the background, distorting brightness or color of at least a portion of the background and/or the image, and/or distorting a shape or size of at least a portion of the image and/or the background.

In the alternative, the deterring step may include the step(s) of blocking at least a portion of the incident light rays emitted by a light source toward the image, blocking at least a portion of the first light rays, blocking at least a portion of the second light rays, distorting at least a portion of the above light rays, and/or adding auxiliary light rays to at least one of the above light rays. The blocking step may also include the step(s) of absorbing at least a portion of at least one of the above light rays, and deflecting at least a portion of at least one of the above light rays in a direction different from, e.g., another direction in which the rest of the light rays travel.

The distorting step may include the step(s) of mis-aligning at least a portion of at least one of the above light rays, and deflecting at least a portion of at least one of the above light rays in one direction which is slightly or substantially different from another direction along which the rest of the above light rays travel. In the alternative, the distorting step may include the step of adjusting an extent of the distortion by the O-A agent according to a source incident angle of incident light rays emitted by a light source toward the image, a first projection angle of the first light rays, and/or a second projection angle of the second light rays. The O-A agent and/or the O-A sheet may be arranged to obtain a maximum extent of the distortion when at least one of the above angles is greater than 30°, 45°, 60°, 75° or 85°. Alternatively, the O-A agent and/or the O-A sheet may also be arranged to adjust the extent of distortion thereby depending on a first distance between a light source and the image and/or a second distance between the image and a reproduction device. The maximum extent of the distortion may be obtained when at least one of the distances is less than 3 feet, 1 foot, 9 inches, 7 inches, 5 inches, 3 inches or one inch.

In the alternative, another method may be provided to distort an image provided on a plain sheet. The method may include the steps of providing the image on the plain sheet, attaching an O-A agent onto at least a portion of the plain sheet, distorting paths of light rays projected upon the image by the O-A agent, thereby distorting the image provided on the plain sheet.

In another aspect of the invention, a method is provided to produce an O-A sheet. The method may include the steps of providing a plain sheet having an image provided thereon and capable of emanating first light rays that have a regular distribution pattern representing the image, delivering an O-A agent onto at least a portion of the plain sheet where the O-A agent is capable of distorting the paths of light rays projected thereupon, and attaching the O-A agent to the plain sheet. Thus, the plain sheet may be converted to an O-A sheet capable of emanating the second light rays with a distorted distribution pattern of the image which is different from the regular distribution pattern representing the image.

Embodiments of this aspect of the present invention may include one or more of the following features.

The delivering step may include the step(s) of placing the O-A agent which has a continuous solid structure over at least a portion of the plain sheet, distributing the O-A agent having a non-continuous solid structure over at least a portion of the plain sheet, and/or applying the O-A agent having a non-solid structure onto at least a portion of the plain sheet. The above placing step may include the step of arranging the O-A agent to have a surface structure having, e.g., a protrusion, groove, and/or aperture, unevenly or evenly over at least a substantial portion of the plain sheet. The above distributing step may also include the step of evenly or unevenly distributing the O-A agent having the non-continuous solid structure over at least a substantial portion of the plain sheet. The above applying step may further include the step of applying the O-A agent having the non-solid structure evenly or unevenly to at least a substantial portion of the plain sheet.

The attaching step may also include the step of forming one of the various types of non-peelable bondings between the plain sheet and the O-A agent. Alternatively, the attaching step may include the step(s) of laminating the O-A agent onto the plain sheet, gluing the O-A agent onto the plain sheet, providing an adhesive layer between the O-A agent and plain sheet, creating electric or electronic force between the O-A agent and plain sheet, binding or embedding the O-A agent into the plain sheet mechanically or by other appropriate mechanisms, and/or drying the O-A agent having a non-solid structure to form a solid structure on the plain sheet. The attaching step may further include the steps of converting the O-A agent into an intermediate O-A compound through, e.g., a chemical reaction and adhering the intermediate O-A compound onto the plain sheet.

In the alternative, another method may be provided to make an O-A sheet. The method may include the steps of providing a plain sheet which has an image provided thereon, delivering onto at least a portion of the plain sheet an O-A agent capable of distorting paths of light rays projected thereupon, and attaching the O-A agent to the plain sheet, thereby converting the plain sheet to an O-A sheet which is capable of distorting the image provided on the plain sheet.

In yet another aspect of the invention, a process may be provided to make an O-A sheet which includes a plain sheet which has an image provided thereon and is capable of emanating first light rays having a regular distribution pattern representing the image. In general, the process includes the steps of providing an O-A agent having a structure for distorting paths of light rays projected thereupon, delivering the O-A agent to at least a portion of the plain sheet, and forming the O-A sheet by attaching the O-A agent onto the plain sheet, so that the O-A sheet has a sheet structure capable of emanating second light rays having a distorted distribution pattern of the image which is different from the regular distribution pattern representing the image.

Embodiments of this aspect of the present invention may include one or more of the following features.

The structure of the O-A agent may be arranged to distort the paths of the light rays by reflecting, refracting, diffracting, and/or transmitting light rays projected thereon. The structure may be provided to the O-A agent by, e.g., providing thereto a continuous solid structure, a non-continuous solid structure, a non-solid structure, and/or a mixture thereof. The continuous solid structure may be provided by arranging ,e.g., a protrusion, groove, and/or aperture thereto evenly or unevenly over at least a substantial portion of the O-A agent. The delivering step may further include the step of evenly or unevenly distributing the O-A agent over at least a substantial portion of the plain sheet.

The O-A sheet may also be made by the step of forming a non-peelable bonding between the plain sheet and the O-A agent. Alternatively, the O-A sheet may be formed by laminating the O-A agent onto the plain sheet, gluing the O-A agent onto the plain sheet, providing an adhesive layer between the O-A agent and the plain sheet, creating electric or electronic force between the O-A agent and plain sheet, mechanically binding or embedding the O-A agent into the plain sheet, and/or drying the O-A agent having a non-solid structure to form a solid structure on the plain sheet.

The sheet structure of the O-A sheet may be arranged to emanate the second light rays by reflecting, refracting, diffracting, and/or transmitting light rays projected thereon. In the alternative, the sheet structure of the O-A sheet may be arranged to determine the optical properties of the second light rays by adjusting an extent of distortion caused by the O-A agent based on a source incident angle of the incident light rays emitted by a light source toward the image, a first projection angle of the first light rays emanating from the plain sheet, and/or a second projection angle of the second light rays emanating from the O-A sheet. In addition, the sheet structure of the O-A sheet may be adjusted to have a maximum distortion when at least one of the above angles is greater than 30°, 45°, 60°, 75° or 85°. In addition, the sheet structure may be arranged to determine the optical properties of the second light rays by adjusting an extent of distortion by the O-A agent based on a first distance between a light source and the image and/or a second distance between the image and a reproduction device. The sheet structure of the O-A sheet may further be adjusted to have a maximum extent distortion when at least one of the distances is less than 3 feet, 1 foot, 9 inches, 7 inches, 5 inches, 3 inches or one inch.

The sheet structure of the O-A sheet may be arranged to generate the distorted distribution pattern of the image by various methods, e.g., changing brightness or color of at least a portion of the image into that of a background, by changing brightness or color of at least a portion of the background into that of the image, obscuring brightness or color difference between the image and the background, by distorting brightness or color of at least a portion of the image and/or the background, and/or by distorting a shape or size of at least a portion of the image and/or the background. In addition, the sheet structure of the O-A sheet may be arranged to generate the distorted distribution pattern of the image, e.g., by blocking at least a portion of the incident light rays emitted by a light source to the image, blocking at least a portion of the first and/or the second light rays, distorting at least a portion of at least one of the above light rays, and/or adding auxiliary light rays to at least one of the above light rays. The blocking step may include the step(s) of absorbing at least a portion of the light rays and/or deflecting at least a portion of the light rays in a direction that is substantially different from another direction in which the rest of the light rays travel. The distorting step may also include the step(s) of mis-aligning at least a portion of at least one of the above light rays and/or deflecting at least a portion of at least one of the above light rays, e.g., in a direction slightly different from another direction in which the rest of the rays travel.

Alternatively, an O-A sheet may be made by another process including the steps of providing a plain sheet with an image provided thereon, delivering an O-A agent onto at least a portion of the plain sheet, and attaching the O-A agent to the plain sheet, thus converting the plain sheet with the image thereon into the O-A sheet which is capable of distorting the image provided on the plain sheet. In the alternative, an O-A sheet may be made by a process including the steps of providing a plain sheet with an image provided thereon, delivering an O-A agent to at least a portion of the plain sheet, attaching the O-A agent to the plain sheet, distorting paths of light rays projected on the O-A agent, and distorting the image provided on the plain sheet. In addition, an O-A sheet may include a plain sheet with an O-A agent and an image provided thereon. Such O-A sheet may be made by a process including the steps of delivering the O-A agent onto at least a portion of the plain sheet, attaching the O-A agent to the plain sheet, thereby forming the O-A sheet; and distorting the image provided on the plain sheet. Furthermore, an O-A sheet may include a plain sheet having an image provided thereon and capable of emanating first light rays having a regular distribution pattern representing the image. Such O-A sheet may be made by a process including the steps of providing an O-A agent capable of distorting paths of light rays projected thereupon, delivering the O-A agent onto at least a portion of the plain sheet, and forming the O-A sheet by attaching the O-A agent onto the plain sheet.

In yet another aspect of the present invention, a device may be provided in order to convert a plain sheet into an O-A sheet having thereon an O-A agent. The plain sheet may include an image provided thereon and capable of emanating first light rays having a regular distribution pattern representing the image, the O-A agent capable of distorting paths of light rays projected thereon, and the O-A sheet capable of emanating second light rays having a distorted distribution pattern of the image which is different from the regular distribution pattern representing the image. Such device may include a sheet receiver for receiving the plain sheet, an agent receiver for receiving thereinto the O-A agent, a delivery unit for delivering the O-A agent to at least a portion of the plain sheet, and an attaching unit capable of attaching the O-A agent onto the plain sheet. It is appreciated that, instead of the agent receiver, a storage unit may be used to store and supply the O-A agent.

Embodiments of this aspect of the present invention may include one or more of the following features.

The sheet-making device may include a dispenser unit capable of dispensing the O-A sheet from the device.

Alternatively, a device may be provided to include a receiver for receiving a plain sheet with an image provided thereon, a storage unit for storing an O-A agent, a delivery unit for delivering the O-A agent from the storage unit onto at least a portion of the plain sheet, and an attaching unit capable of attaching the O-A agent onto the plain sheet, thereby converting the plain sheet into the O-A sheet capable of distorting a distribution pattern of light rays representing the image. In yet another alternative, such device may be arranged to include a receiver for receiving the plain sheet with an image, a storage unit for storing an O-A agent capable of distorting paths of light rays projected thereon, a delivery unit for delivering the O-A agent onto at least a portion of the plain sheet, and an attaching unit capable of attaching the O-A agent one to the plain sheet while at the same time maintaining the distortion capability of the O-A agent, thereby forming the O-A sheet.

In yet another aspect of the invention, a method is provided for operating a sheet-making device capable of converting a plain sheet into an O-A sheet containing an O-A agent thereon. The plain sheet generally has an image provided thereon and is capable of emanating first light rays having a regular distribution pattern representing the image, the O-A agent is capable of distorting paths of light rays projected thereupon, and the O-A sheet is capable of emanating second light rays having a distorted distribution pattern of the image which is different from the regular distribution pattern which represents the image. The sheet-making method may include the steps of feeding a plain sheet into the device, delivering the O-A agent onto at least a portion of the plain sheet, and passing the plain sheet including the O-A agent disposed thereon through an attaching unit of the above device, thereby converting the plain sheet into the O-A sheet.

Alternatively, another method is provided for operating a sheet-making device of converting a plain sheet into an O-A sheet. The method includes the steps of feeding a plain sheet having an image provided thereon into the device, delivering an O-A agent from a storage unit of the device to at least a portion of the plain sheet, and passing the plain sheet having the O-A agent distributed thereon through an attaching unit of the device, thus converting the plain sheet into the O-A sheet which is capable of distorting a distribution pattern of light rays representing the image.

In yet another aspect of the present invention, a sheet-converting device may be provided to convert a plain sheet into an O-A sheet having thereon an O-A agent. The plain sheet has an image provided thereon and is capable of emanating the first light rays having a regular distribution pattern representing the image, the O-A agent is capable of distorting the paths of the light rays projected thereupon, and the O-A sheet is capable of emanating second light rays having a distorted distribution pattern of the image that is different from the regular distribution pattern which represents the image. The sheet-converting device may be coupled to a reproduction device capable of providing the image on the plain sheet. The sheet-converting device includes, e.g., a receiver capable of receiving the plain sheet having the image thereon from the printing device, a storage unit for storing the O-A agent, a delivery unit for delivering the O-A agent onto at least a portion of the plain sheet, and an attaching unit capable of attaching the O-A agent to the plain sheet.

Embodiments of this aspect of the present invention may include one or more of the following features.

The device may also include a dispenser unit capable of dispensing the O-A sheet from the device toward the reproduction device or to an exterior of both of the device and the reproduction device. Examples of the reproduction device may include, but not limited to, a camera, movie camera, video camera, copy machine, scanner, facsimile, CCD (charge-coupled device), OCR (optical character recognition device), acoustic-wave imaging device, and/or any other electromagnetic wave imaging device.

In yet another aspect of the present invention, a sheet-converting device may be provided for converting a plain sheet into an O-A sheet having thereon an O-A agent. In general, the plain sheet has an image provided thereon and is capable of emanating first light rays having a regular distribution pattern representing the image, the O-A agent is capable of distorting paths of light rays projected thereon, and the O-A sheet is capable of emanating second light rays having a distorted distribution pattern of the image that is different from the regular distribution pattern representing the image. Such device may include a coupler capable of coupling the device to a reproduction device capable of providing the image on the plain sheet, a receiver for receiving the plain sheet having the image thereon from the reproduction device, a storage unit capable of storing the O-A agent, a delivery unit for delivering the O-A onto at least a portion of the plain sheet, and an attaching unit capable of attaching the O-A agent onto the plain sheet.

As used herein, the term “sheet” generally refers to any printable medium having any shape, size, thickness, density, weight, color, texture, and/or surface characteristics. In general, the “sheet” includes an image (defined below) and is capable of emanating the first light rays having a regular distribution pattern (defined below) representing the image. The “sheet” is generally produced by processing pulp (defined below) by a variety of conventional sheet-making processes. A typical example of such “sheet” is paper. However, the “sheet” may include any other printable media made of materials at least a substantial portion of which does not have the pulp-like structure. Examples of the non-pulp “sheet” may include, but not limited to, a fabric sheet, plastic sheet, metallic sheet, and/or sheet made of inorganic or non-metallic material, e.g., silicon or compounds thereof. The “sheet” may also refer to a display element of any display devices such as cathode ray tubes, liquid crystal displays, plasma display panels, laser display devices and/or other electric, electronic, and/or optical devices. The “sheet” may further include electronic paper which is capable of forming images thereon by electrically manipulating electronic ink made up of spherical micro-capsules filled with, e.g., liquid dye and solid pigment chips. The “sheet” is generally of a rectangular shape but may be provided in any desirable shapes. Examples of such non-rectangular shapes may include, but not limited to, strips, screens, meshes, and/or other polygonal or curvilinear shapes.

A “printing” generally means any conventional process for producing the “image” on the sheet. The “image” collectively refers to any marks and/or impressions provided on the sheet and may also include a blank “image” of the sheet without any marks or impressions provided thereon. Examples of the “image” may include, but not limited to, alphanumeric characters, symbols, drawings, pictures, and/or any mechanical structures such as protrusions, grooves, and/or apertures. Examples of the “printing” process may include, but not limited to, any conventional methods for producing such images using graphite, carbons, inks, dyes, pigments, paints, and/or other image-creating devices. The “printing” process may be performed manually, by any conventional printing devices which may include, but not limited to, a typewriter, ribbon printer, ink-jet printer, laser printer, color printer, and thermal printer, and/or by any conventional mechanical devices capable of making such images on the sheet. The “printing” process may further include electric manipulation of the above-described display elements and/or electronic paper for producing the “image” thereon. Unless otherwise referred to heretofore and hereinafter, the term “sheet” collectively refers to a sheet without any “images” thereon as well as a sheet carrying the “image” provided by the above-described “printing” processes. It is appreciated that the term “sheet” may also collectively refer to a plain sheet (defined below) as well as an optically active sheet (defined below).

The term “pulp” generally refers to any fibrous materials for producing the sheet. The “pulp” may be prepared from a source material containing cellulose, lignin, and/or other organic fibrous materials obtainable from the plants, trees, and/or recycled paper. For simplicity, the “pulp” may collectively include any conventional ingredients of the sheet such as dyes, pigments, fillers, binding agents, conductive agents, plastics, and/or other additives conventionally used in manufacturing the sheet. The “pulp” may also include material for making the sheet having non-fibrous structure such as flakes.

An “optically active” property of a material generally refers to an ability thereof to distort (defined below) paths of light rays projected thereon by optical mechanisms such as reflection, refraction, diffraction, and/or transmission. The term “optically active” may be abbreviated as “O-A” heretofore and hereinafter. An “O-A agent” generally refers to any material having the “O-A” property. Many properties of a material may render the material to qualify as the “O-A agent.” Examples of such attributes may include, but not limited to, a shape of the material, surface characteristics of the material,, and/or any other intrinsic properties of the material such as mechanical, chemical, electrical, optical, and/or other physical properties thereof. The “O-A agent” may be made from polymers, metals, inorganic materials, and/or other substances offering non-negligible reflective, refractive, diffractive, and/or transmitting properties. Typical examples of such “O-A agents” are poly-ethylene, poly-propylene, aluminum, glass, fluorescent compounds, and crystalline materials such as liquid crystal. The “O-A agent” may be provided in a shape of a film, sheet, mesh, strip, and/or screen, and may also be provided as powder, particulate, beads, flakes, shrapnels, rods, tubes, cones, spheres, hemispheres, threads, wires, spray, aerosols, gums, gels, pastes, and/or solutions. Although there is no general constraint in its size, the “O-A agent” may be sized to have a characteristic dimension which is greater than that of the pulp but less than that of the image provided on the plain sheet. The “O-A agent” may be manufactured from transparent material, but may further be made of semi-transparent, translucent, opaque, and/or mirror-like material, if the material provides at least non-negligible surface reflection, refraction, diffraction, and/or transmission. The “O-A agent” may also be capable of being charged electrically and/or magnetically such that the “O-A agent” may become activated and/or oriented along an electric and/or magnetic field generated therearound.

The O-A agent is delivered onto at least a portion of the “plain sheet” which does not include a substantial amount of the O-A agent. The O-A agent is then “attached” to the “plain sheet,” thereby forming an “O-A sheet” capable of emanating second light rays having a distorted distribution pattern (defined below) of the image different from the regular distribution pattern (defined below) representing the image. Typically, the O-A agent and the “plain sheet” are arranged to form non-peelable bonding therebetween so that the O-A sheet includes a first layer of the “plain sheet” non-peelably attached to a second layer of the O-A agent. As described above, the O-A agent may be provided to have the continuous solid structure, the non-continuous solid structure, and/or the non-solid structure. The O-A agent may also be provided to have a surface structure such as a protrusion, a groove, and/or an aperture. According to the need, these solid, non-solid, and/or surface structures may be distributed evenly or unevenly over a portion of the O-A agent. The O-A agent may be attached to the “plain sheet” by a physical, chemical, electronic, electric, and/or magnetic process through interaction, deformation, reaction, adhesion, coupling, and/or orientation. For example, a thermoplastic O-A agent may be attached to the “plain sheet” by lamination, i.e., applying heat to the O-A agent, plain sheet or both without changing any chemical properties thereof. In the alternative, an inorganic or metallic O-A agent may be attached to the “plain sheet” by, e.g., providing an adhesive layer between the O-A agent and the “plain sheet” or embedding the O-A agent into the “plain sheet.” The properties as well as surface characteristics of the O-A agent may be altered during and/or after the attaching process, as long as the O-A agent in the “O-A sheet” elicits the optical properties described above. Due to the wide variety of the O-A agents and the differences in their structures and/or properties, selection of a suitable attaching mechanism for a particular “plain sheet” is generally a matter of choice of one of ordinary skill in the art. For simplicity, the “O-A sheet” may be distinguished, heretofore and hereinafter, from the “plain sheet” or simply the “sheet” which does not include a substantial amount of the O-A agents. As was briefly described above in this paragraph, contrary to the “plain sheet” emanating the first light rays having the regular distribution pattern (defined below) representing the image, the “O-A sheet” emanates the second light rays having the distorted distribution pattern (defined below) of the image which is different from the regular distribution pattern (defined below).

A “regular distribution pattern” of the first light rays generally means the pattern of the light rays emanating from the plain sheet and representing the image provided on the plain sheet. In general, an observer or an image reproduction device can receive the first light rays having the “regular distribution pattern” if and only if the first light rays are not optically altered or distorted after being emanated from the plain sheet. To the contrary, a “distorted distribution pattern” of the second light rays means the pattern of the light rays emanating from the O-A sheet and representing a (at least) non-negligibly distorted version of the image which is to be supplied to the image reproduction device in a mono-chromic and/or color mode. Examples of the image reproduction devices may include, but not limited to, a camera, movie camera, video camera, copy machine, scanner, fax machine, charge-coupled device (CCD), optical character recognition device (OCR), acoustic-wave imaging device, electromagnetic wave imaging device, and/or any other conventional imaging devices. The “distorted distribution pattern” of second light rays generally results from at least one of the light rays reflected by the plain sheet, refracted by the plain sheet, and/or transmitted into the plain sheet as well as by the light rays reflected by the O-A agent, refracted by the O-A agent, and/or transmitted into the O-A agent. The “distribution pattern” of the light rays is generally determined by the optical characteristics of the plain sheet as well as the O-A sheet, and in most of the cases, by the reflection properties thereof. However, other optical mechanisms may also play a role in forming the final “distribution pattern” of the light rays emanating from the plain sheet and/or the O-A sheet.

The degree of distortion in the distribution pattern of the second light rays may be quantitatively assessed by using a “distortion ratio” which is defined as a ratio of an intensity of the second light rays having the distorted distribution pattern to that of the first light rays having the regular distribution pattern. In order to obtain a meaningful distortion ratio, the same light source is used to emit the same incident light rays toward the image of the plain sheet and the O-A sheet at the same source incident angle from the same distance. The intensities of the first and second light rays are also measured by the same light collector having a pre-specified cross-sectional area and facing the image at the same angle from the same distance. Because the O-A agent disposed in the O-A sheet tends to scatter or disperse the light rays emitted thereto, the distribution pattern thereof is also distorted and/or dispersed, and less light rays reach the above-described light collector. Accordingly, the “distortion ratio” may be always less than 1.0. By the same token, the more the O-A sheet scatters or disperses the light rays projected thereon, the less the “distortion ratio” becomes. It is noted that the intensities of the first and the second light rays generally depend on an incident angle of the incident light rays, a first projection angle of the first light rays, and/or a second projection angle of the second light rays. However, the “distortion ratio” may become relatively independent of the above described incident and/or projection angles because the effects of the angles on the numerator and the denominator of the “distortion ratio” roughly cancel each other.

Unless otherwise defined in the specification, all technical and scientific terms used herein have the same meaning as commonly understood by one of ordinary skill in the art to which the present invention belongs. Although the methods and/or materials equivalent or similar to those described herein can be used in the practice or testing of the present invention, the suitable methods and/or materials are described below. All publications, patent applications, patents, and/or other references mentioned herein are incorporated by reference in their entirety. In case of conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIG. 1 is a schematic diagram of optical elements of a conventional photo-copier.

FIG. 2 is a schematic diagram of optical elements of a conventional scanner.

FIG. 3 is a schematic diagram of a plain sheet having images thereon.

FIG. 4 is a schematic diagram of optical mechanisms for generating light rays that emanate from a plain sheet.

FIG. 5 is a schematic diagram of optical mechanisms for generating light rays that emanate from a laminated sheet.

FIG. 6 is a schematic diagram of one embodiment of an optically active sheet according to the present invention,

FIG. 7 is a schematic diagram of another embodiment of an optically active sheet according to the present invention.

FIG. 8 is a schematic diagram of optical mechanisms for dispersing and distorting a single incident light ray emitted from a light source.

FIG. 9 is a schematic diagram of optical mechanisms for projecting multiple light rays of different origins onto a single location.

FIG. 10 is another schematic diagram of a plain sheet having images thereon.

FIG. 11 is an exploded view of a portion of the images on the plain sheet of FIG. 10.

FIG. 12 is another schematic diagram of optical mechanisms for dispersing and distorting incident light rays emitted from a light source.

FIG. 13 is a schematic diagram of several exemplary embodiments of surface structure of an optically active agent according to the present invention.

FIG. 14 is a schematic diagram of a sheet-making device according to the present invention.

### DETAILED DESCRIPTION

The present invention generally relates to an optically active sheet that includes a layer of a plain sheet and another layer of an optically active agent. The plain sheet has an image and is capable of emanating light rays representing the image. The optically active agent is attached onto the plain sheet and is arranged to disperse or distort the paths of light rays projected thereon. Accordingly, the optically active sheet disperses or distorts the paths of the light rays representing the image and, therefore, deterring unauthorized reproduction of the image provided therein.

Conventional image acquisition, reproduction, processing, and/or editing devices (collectively referred to as “reproduction device” hereinafter) include, e.g., three essential optical elements, i.e., a light source, light pathway, and light collector. The light source is arranged to provide illumination to the image on the plain sheet so that the plain sheet emanates light rays having a distribution pattern representing the image. Conventional monochromic or color light bulbs, laser tubes, and/or any other conventional illumination devices may be used as the light source. The light pathway is arranged to direct and/or guide the light rays toward the light collector. The light pathway may be formed by a variety of conventional optical units capable of directing, focusing, and/or dispersing the light rays. Examples of such optical units may include, but not limited to, lenses, mirrors, prisms, filters, polarizers, colored articles, optical fibers, and a combination thereof. The light collector serves the functions of collecting the light rays emanating from the plain sheet and converting them into another form of signals which can be used to reproduce the image provided on the plain sheet. Examples of such light collectors may include, but not limited to, a printing drum, a light sensitive tube, and/or a charge coupled device (CCD). The printing drum is generally made of metallic material and arranged to have a negative charge on its surface. When the light pathway delivers the light rays of the image onto the surface of the printing drum, the areas stricken with the light rays lose the negative charge, while leaving the rest of the printing drum charged to represent the dark parts of the image. Positively charged particles of toner powder are then applied to the drum such that the negatively charged portion of the drum attracts the toner powder and forms a dark portion resembling the image on the plain sheet. The toner powder is transferred to a paper during the printing or copying process. To the contrary, the CCD is a microchip with an array of numerous tiny light-sensitive elements having photo-diode such as a reverse-biased p-n semiconductor junction. When the light pathway delivers the light rays of the image to the light-sensitive elements, the light rays free electrons and produce a certain level of negative electric charge which varies according to the intensity of the light rays. In general, multiple light-sensitive elements are arranged to form multiple rows and columns thereof, where each row of elements may process one line of the image. Electrodes behind the photo-diodes move the charge from the rows of the light sensitive elements to the CCD's output to form the image signal.

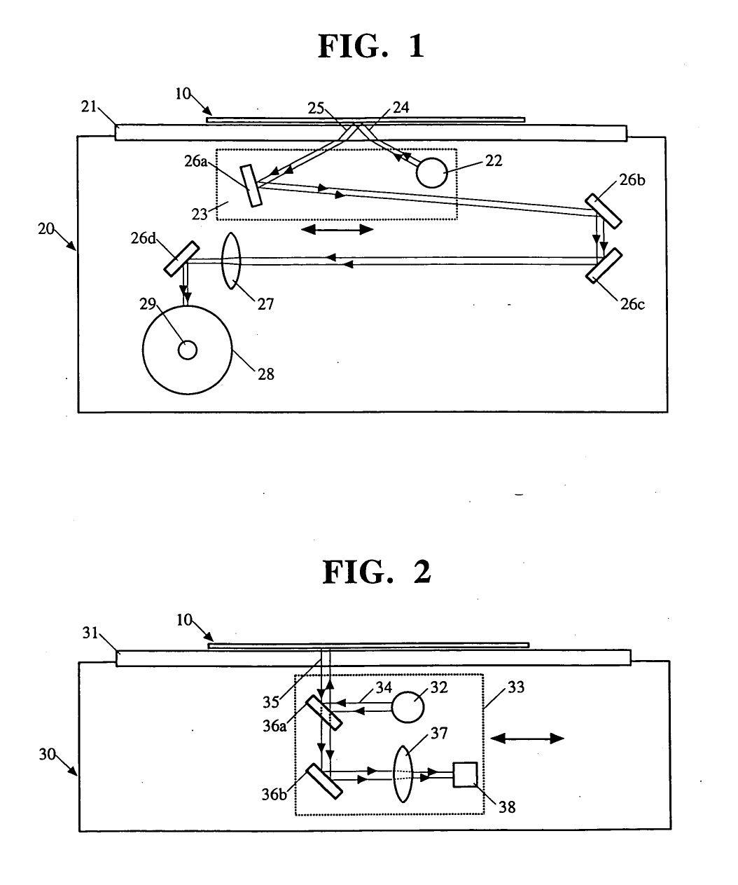

Conventional optical elements used in the conventional reproduction device and the operations thereof will now be illustrated in greater detail, and the underlying optical mechanisms will be identified. FIGS. 1 and 2 schematically illustrate operations of a few of the image reproduction devices utilizing the above-described light collectors. FIGS. 3 through 5 schematically describe the optical mechanisms responsible for generating the first light rays that represent an image on a plain sheet and emanate from the plain sheet and from a sheet coated with a conventional lamination film.

FIG. 1 is a schematic diagram of optical elements of a conventional photo-copier. A plain sheet 10 including an image (not shown) thereon is placed on a glass window 21 of a photo-copier 20 with its image-bearing surface facing down. A cover (not shown) may be provided so as to cover the plain sheet 10 during the reproduction process. A light source 22 is provided in a mobile unit 23 of the photo-copier 20 and arranged to project incident light rays 24 onto the plain sheet 10 through the glass window 21. In the embodiment shown in FIG. 1, the light source 22 is arranged to project the incident light rays 24 at an acute angle with respect to the glass window 21. By reflection, refraction, and/or transmission, the plain sheet 10 emanates first light rays 25 toward the mobile unit 23 of the photo-copier 20 through the glass window 21 so that the first light rays 24 have a distribution pattern representing the image provided on the plain sheet 10. The first light rays 25 are then guided through an optical pathway defined by reflective mirrors 26a, 26b, 26c, 26d and a focusing lens 27, and delivered to a printing drum 28. When the first light rays 25 strike a portion of the printing drum 28, the negative electric charges generated thereon disappear, leaving the rest of the printing drum 28 struck by dark portion of the image to remain charged. By applying positively charged particles of toner powder, the charged part of the printing drum 28 attracts the toner particles and forms a pattern representing a portion of the image provided on the plain sheet 10. The toner particles are transferred to a sheet of paper (not shown) fed through a paper pathway (not shown). By moving the mobile unit 23 along a length of the plain sheet 10 and by rotating the printing drum 28 at a corresponding speed, the image of the entire plain sheet 10 can be reproduced on the surface of the printing drum 28. As the reproduction process proceeds, a heater (not shown) seals the toner particles to the paper so that a warm copy of the plain sheet 10 emerges from the photo-copier 20. For simplicity, other parts of the photo-copier such as an erase lamp and charge transfer or have been omitted in FIG. 1.

FIG. 2 is a schematic diagram of optical elements of a conventional scanner. The plain sheet 10 including an image (not shown) thereon is placed on a glass window 31 of a scanner 30 with its image-bearing surface facing down. A cover (not shown) may also be provided so as to cover the plain sheet 10 during the scanning process. A light source 32 is provided in a mobile unit 33 of the scanner 30 and arranged to project incident light rays 34 onto the plain sheet 10 through the glass window 31. In this embodiment, the light source 32 is arranged to project the incident light rays 34 parallel to the glass window 31 and toward a semi-transparent mirror 36a which reflects the incident right rays 34 to the plain sheet 10 in a substantially vertical and upward direction. By reflection, refraction, and/or transmission, the plain sheet 10 emanates first light rays 35 downwardly toward the semi-transparent mirror 36a through the glass window 21. The first light rays 35 having a regular distribution pattern representing the image provided on the plain sheet 10 is transmitted downwardly through the semi-transparent mirror 36a and guided toward a CCD 39 through an optical pathway defined by a reflective mirror 36b and a focusing lens 37. The CCD 38 is arranged to collect the first light rays 35 and generate electric signals representing a portion of the image provided on the plain sheet 10. By moving the mobile unit 33 along a length of the plain sheet 10, the images on the entire plain sheet 10 can be converted into electric signals.

FIG. 3 is a schematic diagram of a plain sheet 10 which includes thereon images of multiple rectangles 11, 12, where one rectangle 11 is shaded darker than the other 12 and separated from the other 12 by a blank portion 13. For illustration purposes only, an X—Y coordinate system is employed so that the X-coordinate denotes a horizontal direction along a side and/or width of the plain sheet 10, whereas the Y-coordinate represents an orthogonal vertical direction along a length and/or height of the plain sheet 10. Straight lines a-a, b-b, and c-c are drawn in the X-direction to represent different cross-sections of the plain sheet 10 across the darker-shaded rectangle 11, blank portion 13, and lighter-shaded rectangle 12, respectively. A sample area 14 is defined to include the rectangles 11, 12 and the blank portion 13 therein. In general, it is assumed that the sample area 14 roughly corresponds to an unit area which is photo-copied, scanned,, and/or otherwise reproduced in a single operation by a single functional unit of the printing drum 28, the CCD 38 or other reproduction device described above. Accordingly, an actual height of the sample area 14 may depend on numerous factors such as a diameter of the printing drum 28, size of the reflective and semi-transparent mirrors 26a-26d, 36a, 35b, a diameter of the lenses 27, 37, speed of lateral displacement of the mobile units 23, 33 along the width or height of the plain sheet 10, size of a functional-unit of the charging mechanism which generates negative charges on the surface of the printing drum 28, size of a light-sensitive elements of the CCD 38, size of the CCD 38, size, shape, and configuration of the light sources 22, 32, distance between the glass window 21, 31 and the light source 22, 32, and the like.

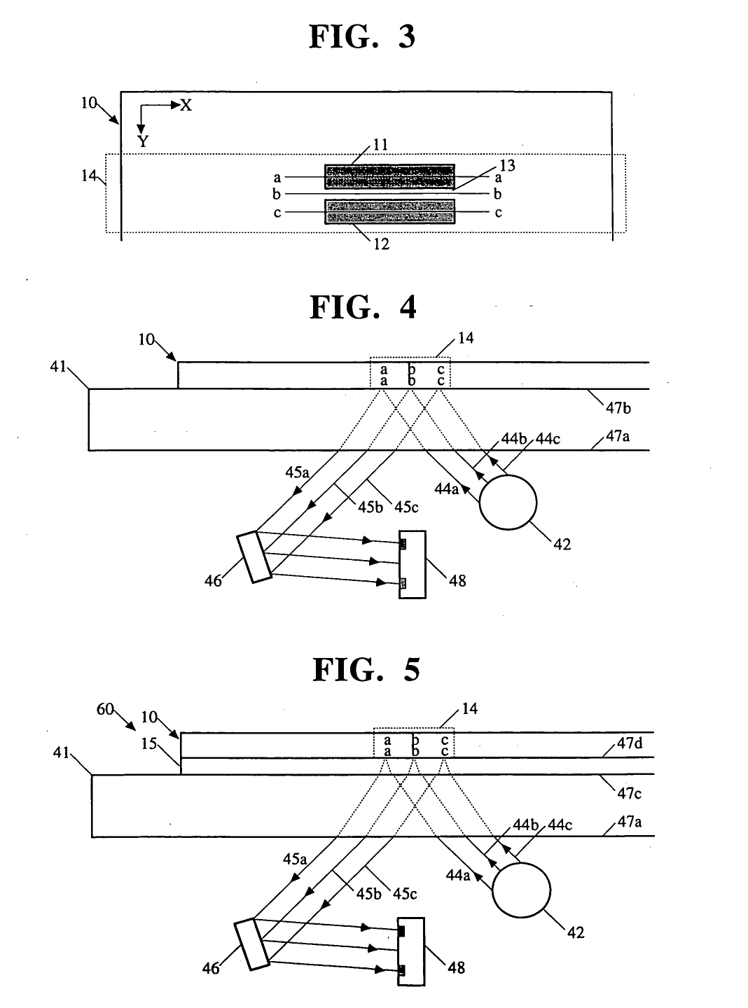

FIG. 4 is a schematic diagram of optical mechanisms for generating light rays that emanate from an image-bearing surface of the plain sheet 10, in particular, a sample area 14 thereof. The plain sheet 10 is placed on the glass window 41 with its image-bearing surface facing toward a light source 42. The light source 42 projects incident light rays toward the cross-sections a-a, b-b, and c-c of the sample area 14 on the plain sheet 10. For illustration purposes only, shown in the figure are only those incident light rays 44a, 44b and 44c that are arranged to strike the cross-sections a-a, b-b, and c-c, respectively. The incident light rays 44a, 44b, 44c are first refracted at an interface 47a between the air and the glass window 41, transmitted through the glass window 41, and strike the cross-sections a-a, b-b, and c-c of the sample area 14. The darker-shaded rectangle 11 is arranged to reflect only a tiny portion of the incident light rays 44a while absorbing the rest thereof, the lighter-shaded rectangle 12 reflects a greater portion of the incident light rays 44c, whereas the blank portion 13 reflects almost all of the incident light rays 44b projected thereupon. As a result, the sample area 14 (or the plain sheet 10) emanates the first light rays 45a, 45b, 45c therefrom. It is appreciated that, because the incident light rays 44a, 44b, 44c evenly project the sample area 14, the first light rays 45a, 45b, 45c are generally parallel to each other and have a regular light distribution pattern representing the images 11, 12, 13. Although the plain sheet 10 emanates the first light rays 45a, 45b, 45c predominantly by reflection, it is appreciated that other optical mechanisms such as refraction, diffraction, and/or transmission may also contribute to the emanation of the first light rays 45a, 45b, 45c as well. It is further appreciated that another interface 47b which is formed between the plain sheet 10 and the glass window 41 may contribute to the emanation of the first light rays 45a, 45b, 45c. The first light rays 45a, 45b, 45c are then transmitted back through the glass window 41, refracted at the interface 47a, and projected upon a mirror 46 which then reflects the first light rays 45a, 45b, 45c to a light collector 48. Therefore, the first light rays 45a, 45b, 45c reproduce the images 11, 12, 13 at the light collector 48 which then converts the first light rays 45a, 45b, 45c into signals of different forms such as electric, mechanical, magnetic, chemical or thermal signals.

FIG. 5 is a schematic diagram of optical mechanisms for generating light rays that emanate from a laminated sheet 16. For example, by applying heat and pressure thereto, a thermo-plastic film 15 can be laminated on an image-bearing surface of the plain sheet 10 so that images 11, 12, 13 provided on the plain sheet 10 are covered by the lamination film 15. The laminated sheet 16 is then placed on the glass window 41 with its laminated portion facing the light source 42. The light source 42 projects incident light rays 44a, 44b, 44c to the cross-sections a-a, b-b, and c-c of the sample area 14. The incident light rays 44a, 44b, 44c are then refracted at an interface 47a between the air and the glass window 41, transmitted through the glass window 41, refracted at another interface 47c between the glass window 41 and the lamination film 15, and evenly projected upon the cross-sections a-a, b-b, and c-c of the sample area 14. The incident light rays 44a, 44b, 44c are reflected by the sample area 14, transmitted through the lamination film 15, and refracted at the interface 47c between the lamination film 15 and the glass window 41, thereby enabling the laminated sheet 16 to emanate the first light rays 45a, 45b, 45c therefrom. The first light rays 45a, 45b, 45c are transmitted through the glass window 41, refracted at the interface 47a between the glass window 41 and air, and projected upon a mirror 46 which reflects the first light rays 45a, 45b, 45c to a light collector 48. Because the lamination film 15 has an uniform thickness and smooth surface, the first light rays 45a, 45b, 45c are parallel to each other and reproduce the images 11, 12, 13 on the plain sheet 10 at the light collector 48 which converts them into one of the above-mentioned signals.

It is appreciated that accuracy or quality of the reproduced images predominantly depends upon whether the first light rays 45a, 45b, 45c maintain their light distribution pattern throughout the optical processes such as reflection, refraction, diffraction, and/or transmission, and through the light pathway until the first light rays 45a, 45b, 45c reach the light collector 48. The more distorted the first light rays 45a, 45b, 45c are, the more distorted the reproduced images are from the original images 11, 12, 13. Therefore, it is one objective of the present invention to intentionally cause dispersion or distortion in the first light rays so as to deter reproduction of the images provided on the plain sheet. Several embodiments of this aspect of the present invention will now be described.

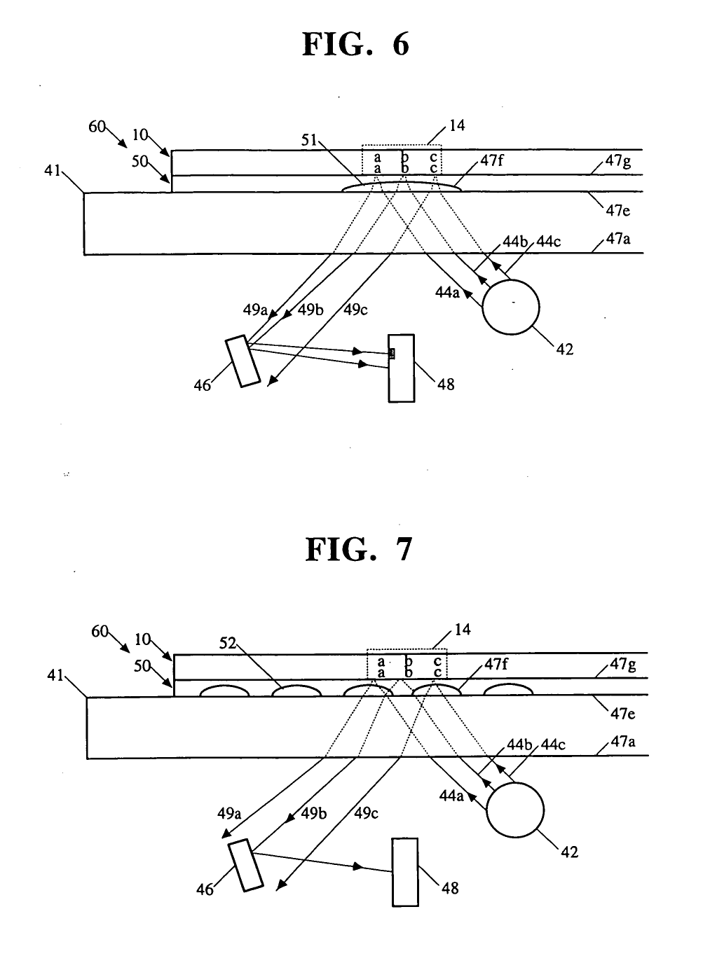

FIG. 6 is a schematic diagram of one embodiment of an optically active sheet (the “O-A sheet” hereinafter) according to one aspect of the present invention, where the O-A sheet is capable of causing dispersion or distortion in the regular distribution pattern of the first light rays 45a, 45b, 45c. The O-A sheet 60 is generally made by attaching an optically active agent 50 (the “O-A agent” hereinafter) onto, e.g., an image-bearing surface of the plain sheet 10. The O-A agent 50 generally includes an internal and/or surface structure capable of distorting the paths of the light rays projected thereupon by various optical mechanisms including, but not limited to, reflection, refraction, diffraction, and transmission. In the figure, the O-A sheet 60 is provided by attaching to the plain sheet 10 a film-type O-A agent 50 including a corrugated hollow groove 51 extending across the side or width of the plain sheet 10. It is appreciated that the groove 51 may be shaped and sized such that a single groove 51 may encompass therein the entire sample area 14 of the plain sheet 10.

In operation, the light source 42 evenly projects the incident light rays 44a, 44b, 44c on the sample area 14 in the O-A sheet 60. The incident light rays 44a, 44b, 44c are first refracted at the interface 47a between the air and the glass window 41, transmitted through the glass window 41, refracted again at another interface 47e formed between the glass window 41 and the air in the groove 51, refracted once more by yet another interface 47f formed between the air in the groove 51 and the O-A agent 50, and then projected on the sample area 14. Depending on the images 11, 12, 13 provided thereon, the sample area 14 reflects the incident light rays 44a, 44b, 44c having different light intensities and/or their projection angles (such as those formed by the reflected light rays with respect to the plain sheet 10 or the glass window 41). The reflected light rays are transmitted through the O-A agent 50 and reach the interface 47f between the O-A agent 50 and the air in the groove 51. By refracting the reflected incident light rays 44a, 44b, 44c once more at the interface 47f between the O-A agent 50 and the air in the groove 51, the O-A agent 50 or the O-A sheet 60 emanates the second light rays 49a, 49b, 49c therefrom. The second light rays 49a, 49b, 49c are then transmitted through the air in the groove 51, refracted at the interface 47e between the air in the groove 51 and glass window 41, transmitted through the glass window 41, refracted yet again at the interface 47a between the glass window 41 and the air, and projected onto the light collector 48.

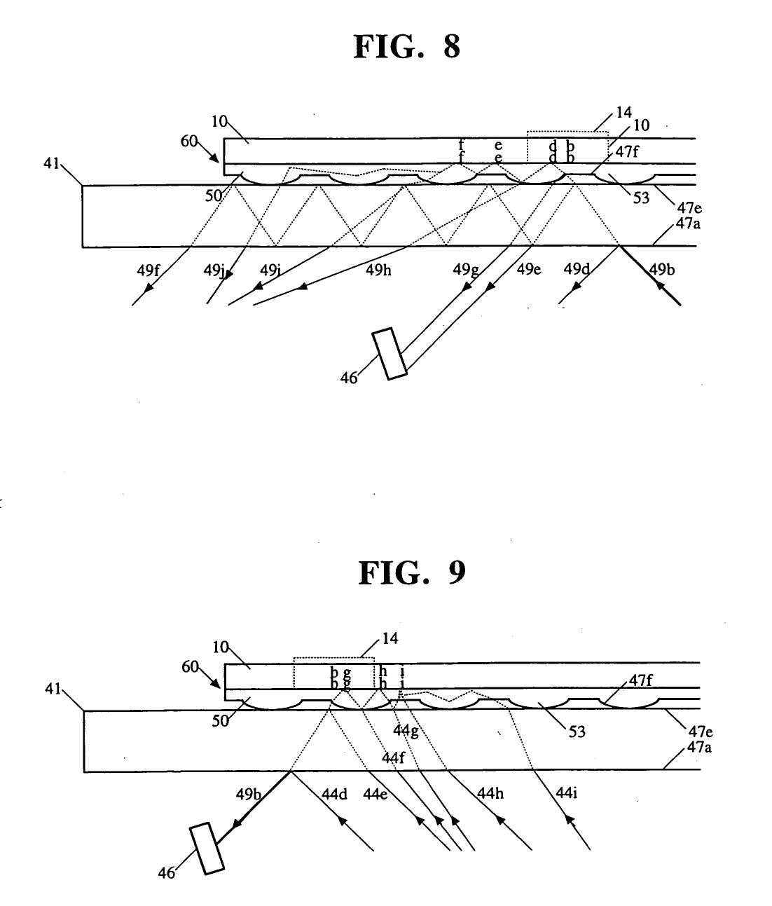

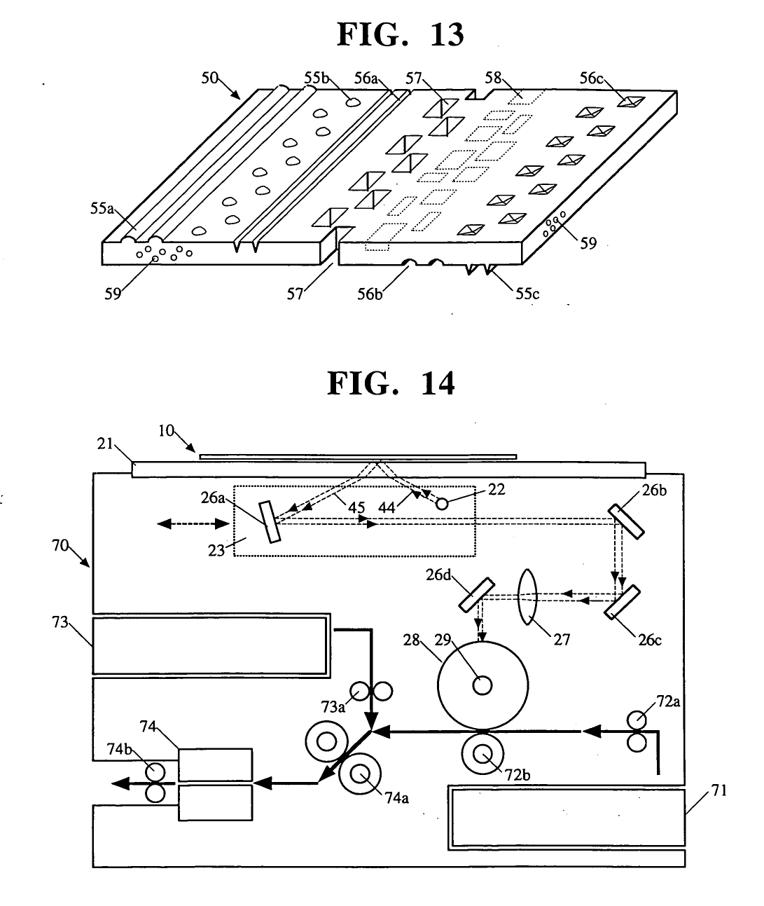

It is appreciated that the curvilinear contour of the surface structure (such as the groove 51 in FIGS. 6, 7, and 13, protrusions in FIGS. 8, 9, 12, and 13, and apertures in FIG. 13) of the O-A agent 50 or the O-A sheet 60 can distort the regular distribution of the incident light rays 44a, 44b, 44c projected on the sample area 14 through the refraction thereby as well as the transmission therethrough. Degree of refraction of light rays at the interface 47f of the O-A agent 50 is generally determined by numerous factors which may include, but not limited to, incident or projection angles of the incident, reflected, and/or refracted light rays, optical characteristics of the O-A agent 50 and, more importantly, the structural and geometrical configuration of the O-A agent 50. It is also appreciated that, because of the irregular diffraction pattern of the incident light rays 44a, 44b, 44c at the interface 47f, the sample area 14 on the plain sheet 10 may not be illuminated evenly or uniformly by the incident light rays 44a, 44b, 44c. For example, the O-A agent 50 may skew the distribution pattern of the incident light rays 44a, 44b, 44c in such a way that more light rays are projected on the darker-shaded rectangle 11 at the cross-section a-a than the lighter-shaded rectangle 12 at the cross-section c-c. This may cause the darker-shaded rectangle 11 to reflect more light rays than the lighter-shaded rectangle 12, thereby rendering the darker-shaded rectangle 11 look brighter than it really is and/or even lighter than the lighter-shaded rectangle 12. Conversely, the O-A agent 50 may skew the distribution pattern of the incident light rays 44a, 44b, 44c such that the blank portion 12 may receive and reflect less light rays, thereby rendering it look darker than it is and/or even darker than the lighter- or darker shaded rectangles 11,12.

It is further appreciated that the curvilinear contour associated with the surface structure (such as the groove 51 in FIGS. 6, 7, and 13, protrusions in FIGS. 8, 9, 12, and 13, and apertures in FIG. 13) can further distort the distribution pattern of the second light rays 49a, 49b, 49c emanating from the O-A agent 50 or the O-A sheet 60 by the irregular refraction of the second light rays 49a, 49b, 49c at the interface 47f. For example, as are exemplified by the light rays 49a and 49b in the figure, the O-A agent 50 may distort the distribution pattern of the second light rays 49a, 49b, 49c so that the reflecting mirror 46 is unevenly or not uniformly projected upon by the second light rays 49a, 49b, 49c. This uneven projection may render at least a portion of the mirror 46 receiving more light rays than the other portions, causing that portion to look brighter or lighter while rendering the other portions look darker. Furthermore, as exemplified by the light ray 49c, at least a portion of the second light rays 49a, 49b, 49c may be severely distorted such that it veers off the light collector 46. This distortion will result in a reproduced image lacking the corresponding portion of the original image (e.g., the light-shaded rectangle 13) provided on the plain sheet 10.

FIG. 7 is a schematic diagram of another embodiment of an O-A sheet according to the present invention, where the O-A sheet is again capable of causing distortion in the regular distribution pattern of the first light rays 45a, 45b, 45c. The O-A sheet 60 is provided by attaching another film-type O-A agent 50 onto an image-bearing surface of the plain sheet 10. It is appreciated that the O-A agent 50 includes the surface structure similar to that illustrated in FIG. 6, with an exception that the structure includes multiple hollow grooves 52 each of which extends across the side or width of the plain sheet 10. It is further appreciated that each groove 52 may be shaped and sized to have a smaller dimension than that of the sample area 14 of the plain sheet 10. As manifested in FIG. 7, the smaller grooves 52 provide more curved contour and, therefore, may be able to more severely distort the distribution patterns of the first light rays 45a, 45b, 45c as well as the refracted light rays thereof. As a result, more second light rays 49a, 49b, 49c veer off the mirror 46 and the light collector 48, resulting in a reproduced image which lacks more portions of the original images 11, 12, 13 provided on the plain sheet 10. For example, in FIG. 9, the second light rays 49a and 49c representing the shaded rectangles 11 and 13 veer off and do not strike the mirror 46 and the light collector 48. Accordingly, an image reproduced by the reproduction device will not include images of any shaded objects thereon.

As discussed above, several mechanisms operate in and around the O-A agent 50 and the O-A sheet 60 such that the resulting second light rays 49a, 49b, 49c emanating from the O-A agent 50 or the O-A sheet 60 have a distorted distribution pattern different from the regular light distribution pattern of the first light rays 45a, 45b, 45c. Therefore, the light collector 48 receiving such second light rays 49a, 49b, 49c can not reproduce the signals correctly duplicating the images 11, 12, 13 on the plain sheet 10. FIGS. 8 and 9 further illustrate several exemplary optical mechanisms inducing such distortions in the first light rays 45a, 45b, 45c and the reflected light rays thereof.

FIG. 8 is a schematic diagram of optical mechanisms for dispersing and distorting incident light rays emitted from a light source. Although a single beam 44b of incident light ray is shown in the figure for illustration purposes only, optical mechanisms which will be described hereinafter apply to all incident light rays projected on the plain sheet 10. The O-A sheet 60 is provided with multiple protrusions 53 extending across the side of the plain sheet 10. The protrusions 53 are shaped and sized to be smaller than that of the sample area 14 of the plain sheet 10. An incident light ray 44b is emitted by a light source 22 toward the image at the cross-section b-b provided on the sample area 14. A portion of the incident light ray 44b is reflected by a surface of the glass window 41 and projected downward as a beam 49d. The rest of the incident light ray 44b is diffracted at the interface 47a and transmitted through the glass window 41. At the interface 47e formed between the glass window 41 and the air between the protrusions 52, another portion of the incident light ray 44b is reflected and transmitted back to the interface 47a, where it may be refracted and projected downward to form a beam 49e or may be reflected between the interfaces 47a, 47e along a length of the glass window 41, refracted, and then projected downward as a beam 49f. The rest of the incident light ray 44b is refracted upward and projected upon the surface of the O-A agent 50 where it may be reflected by the surface, refracted at the interface 47e, and refracted and transmitted downward to form a beam 49g. Alternatively, the incident light ray 44b may be refracted into the O-A agent 50, transmitted through the O-A agent 50, and reflected by the plain sheet 10 while carrying the optical information of the image such as color and/or brightness of the plain sheet 10. This reflected light ray may also be transmitted through the O-A agent 50, refracted again at the interface 47e, transmitted downward through the glass window 41, refracted once more at the interface 47a, and projected downward to form a beam 49h. Alternatively, the reflected light ray may reflect back and forth inside the O-A agent 50 at the intersections 47e, 47f and/or transmitted along the length of the O-A agent 50, and refracted out of the O-A agent 50, transmitted through the intersection 47e, and projects out of the glass window 41 as light beams 49i, 49j.

The above-described optical mechanisms can effectively disperse the single light ray 44b into multiple beams having different projection angles and projection locations of the light source 22. Some of these beams such as 49e, 49g may be projected on the mirror 46 and the light collector 48, while the others such as 49d, 49f, 49h, 49i, 49j veer them off. Therefore, the mirror 46 and the light collector 48 may only receive a certain portion of the incident light ray 44b, resulting in mis-interpretation or distortion of the brightness and/or color of the image at the cross-section b-b on the plain sheet 10.

In addition, each of the above light beams 49d-49j may carry optical information (brightness or color) pertaining to different locations of the optical sheet 60. The beams 49d, 49e, 49f, for example, are the portions of the light ray 44b reflected at the interfaces 47a, 47e and, therefore, do not carry any optical information of the sample area 14. The beam 49g is another portion of the light ray 44b reflected at the interface 47f, and does not carry any optical information of the sample area 14 either. Although the beam 49h has the incident angle capable of being projected on the cross-section b-b on the sample area 14, the O-A agent 50 alters that angle through refraction at the interface 47f. Thus, the beam 49h projects a cross-section d-d instead of the cross-section b-b. To the contrary, the beams 49i, 49j are projected on more than one location on the plain sheet 10 and, therefore, carry optical information which is mixture of the brightness and/or color of the cross-sections d-d, e-e, and f-f. Because the single light ray 44b ends up as multiple light beams 49d-49j which may carry optical information (brightness or color) pertaining to different locations of the optical sheet 60, it becomes virtually impossible to collect light beams and/or light rays which represent undistorted images of the sample area 14.

Furthermore, the optical mechanisms responsible for projecting the light rays such as beams 49d-49j may provide each of the beams 49d-49j with projection angles which are different from an incident angle of the incident light ray 44b. Accordingly, a regular distribution pattern of the incident light rays (such as 44a, 44b, 44c in FIGS. 4 and 5) as well as the first light rays (such as 45a, 45b, 45c in FIGS. 4 and 5) is distorted, resulting in second light rays 49a-49j generally not parallel to each other and having a distorted distribution pattern which is different from the regular distribution pattern. Even if the mirror 46 and the light collector 48 may be able to collect all second light rays 49a-49j, the image reproduced thereby will be only a distorted version of the original images 11, 12, 13 provided on the sample area 14.

FIG. 9 is a schematic diagram of optical mechanisms for projecting multiple light rays of different origins onto a single location. Though a single beam 49b of the second light ray is shown in the figure for illustration purposes only, optical mechanisms which will be described hereinafter apply to all second light rays emanating from the O-A sheet 60. The O-A sheet 60 is provided with multiple protrusions 53 similar to those described in conjunction with FIG. 8 and incident light rays 44d-44h are emitted by a light source toward the O-A sheet 60. The incident light ray 44d is reflected by a surface of the glass window 41 and directly projected downward as a second light ray 49b. The incident light ray 44e is refracted at the interface 47a, transmitted through the glass window 41, reflected back at the interface 47e, transmitted back through the glass window 41, and refracted out of the glass window 41 as the second light ray 49b. The incident light ray 44f is refracted at the interface 47a, transmitted through the glass window 41, refracted at the interface 47e, and refracted up onto a surface of the protrusion 53. Although the incident light ray 44f may have been projected onto the cross-section b-b without the presence of the O-A agent 50, the intervening O-A agent 50 refracts the incident light ray 44f off the cross-section b-b, and projects the ray 44g on the cross-section g-g. The light ray 44f is then reflected by the plain sheet 10, transmitted through the O-A agent 50, refracted at the interfaces 47f, 47e, transmitted again through the glass window 41, and refracted at the interface 47a as the second light ray 49b, while carrying the optical information (such as color and/or brightness) of the cross-section g-g of the plain sheet 10. The incident light ray 44g is emitted at a distance from the incident light ray 44f, and follows the paths parallel to each of those of the incident light ray 44f, and reaches the surface of the protrusion 53. The incident light rays 44g, 44h, 44i are refracted into the O-A agent 50, reflected by the cross-sections g-g, h-h, and i-i respectively, and are bounced up and down inside the O-A agent 50 along the length thereof while carrying the optical information of the cross-sections g-g, h-h, and i-i, respectively. The incident light rays 44g, 44h, 44i are then transmitted and refracted downward as the second light ray 49b.

In general, conventional reproduction devices include a mechanism collecting the first light rays 45a, 45b, 45c emanating from only a portion of the plain sheet 10, e.g., a rectangular portion of the plain sheet 10 extending along the entire side thereof. At least one of the optical elements such as the mirror 46, the light source 22, the light collector 48, and/or the glass window 41 is arranged to move with respect to the others such that the light collector 48 may sequentially collect the first light rays 45a, 45b, 45c which emanate from and represent the entire portion of the plain sheet 10. One example of such embodiment is the mobile unit 23 illustrated in conjunction with FIGS. 1 through 5. By collecting the first light rays 45a, 45b, 45c emanating from the successive strips of sample areas on the plain sheet 10, these reproduction devices provide a photocopy or scanned image of the entire plain sheet 10. The optical mechanisms illustrated in FIG. 9, however, manifest that the O-A agent 50 and/or the O-A sheet 60 can guide multiple light rays 44d-44i projected at different incident angles and/or by the light source 22 at different emission locations toward a single target, such as the mirror 46 or the light collector 48. For example, some of these light rays such as 44h, 44i are projected on the mirror 46 when the light source 22 is located apart from the mirror 46, while others such as 44d-44g can reach the mirror 46 after the light source 22 approaches closer thereto. Therefore, the mirror 46 and the light collector 48 may be projected by the light rays emitted by the light source 22 located at various positions. These optical mechanisms effectively destroy one-to-one correspondence between the images 11, 12, 13 on the plain sheet 10 and those reproduced on a photo-copied sheet or scanned image, thereby distorting the brightness and/or color of the images 11, 12, 13 on the plain sheet 10. It is appreciated that the above dispersion or distortion mechanisms may apply even when the reproduction device is capable of projecting incident light rays on the entire portion of the plain sheet 10, and produces a photocopy or scanned image of the entire page of plain sheet 10.

In addition, the mirror 46 and/or the light collector 48 may end up collecting the incident light rays 44d-44i carrying optical information (brightness or color) pertaining to various locations of the optical sheet 60. For example, the incident light rays 44d, 44e are emitted from the light source 22 and directly reflected at the interfaces 47a, 47e and, therefore, can not carry any optical information of the O-A sheet 60. The incident light rays 44f, 44g, 44h, though projected toward the sample area 14, are refracted by the O-A agent 50 and projected upon cross-sections g-g, h-h, and i-i, respectively. Furthermore, the incident light ray 44i is projected on several locations across the plain sheet 10 and, therefore, carry optical information which is a mixture of brightness and/or color of the cross-sections g-g, h-h, and i-i. Because the single location on the mirror 46 or the light collector 48 is projected upon by multiple incident light rays 44d-44i carrying optical information (brightness or color) pertaining to different locations of the optical sheet 60, it becomes virtually impossible to collect light beams and/or light rays which represent undistorted images of the sample area 14.

Furthermore, the optical mechanisms responsible for projecting the light rays such as beams 44d-44i may enable other incident light rays having different projection angles from an incident angle(s) of the incident light rays 44d-44i in the figure. Accordingly, a regular distribution pattern of the incident light rays (such as 44a, 44b, 44c in FIGS. 4 and 5) as well as the first light rays (such as 45a, 45b, 45c in FIGS. 4 and 5) is distorted, resulting in the second light rays 49b with a distorted distribution pattern different from the regular distribution pattern.

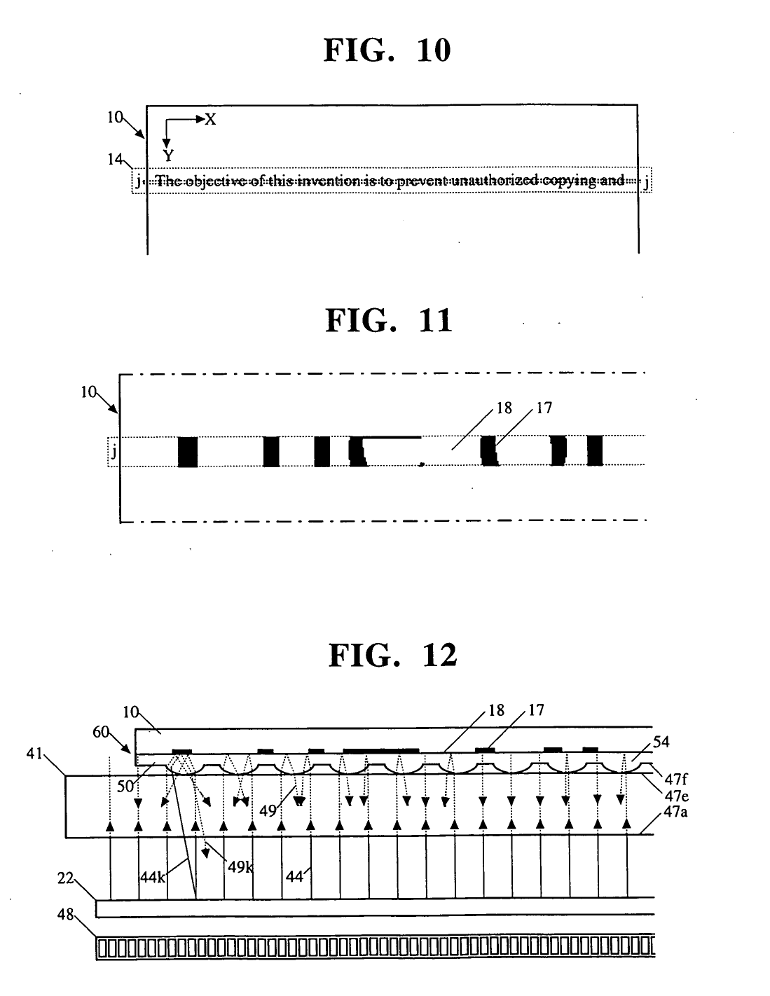

As illustrated above in conjunction with FIGS. 8 and 9, the surface structure and intrinsic optical properties of the O-A agent 50 (and the resulting O-A sheet 60) emanate the second light rays 49a, 49b, 49c having a distorted distribution pattern different from the regular light distribution pattern of the first light rays 45a, 45b, 45c. While the O-A agents 50 shown in FIGS. 8 and 9 include exemplary protrusions 53 extending along the width (the X-coordinate in FIG. 3) of the O-A sheet 60, the O-A agent 50 may as well be provided with surface structure extending along the length (the Y-coordinate in FIG. 3) of the O-A sheet 60, thereby dispersing and/or distorting light distribution pattern in the direction of its height or the Y-coordinate. FIGS. 10 to 12 illustrate such O-A agent 50 and the resulting O-A sheet 60.

FIG. 10 is another schematic diagram of a plain sheet having images such as a line of sentence. Along the width of the plain sheet 10 is drawn an unit area 14 including a cross-section j-j which may be photo-copied, scanned, and/or otherwise reproduced in a single operation by a single functional unit of the light collector 48 of a conventional reproduction device. Actual dimension of the cross-section j-j may depend on numerous factors which have already been described in conjunction with FIG. 3. For example, the cross-section j-j having a greater height may be photo-copied and/or scanned at the same resolution, as the diameter of the printing drum 28, size of the reflective and semi-transparent mirrors 26a-26d, 36a, 35b, diameter of the lenses 27, 37, speed of lateral displacement of the mobile units 23, 33 along the width or height of the plain sheet 10, size of a functional unit of the charging mechanism generating negative charges on the surface of the printing drum 28, size of a light-sensitive elements of the CCD 38, and/or size of the CCD 38 may increase. It is appreciated that the height or length of the unit area may amount to the length of the O-A sheet 60, provided that the light collector 48 can handle the vast amount of optical information.

FIG. 11 is an exploded view of the cross-section j-j on the plain sheet of FIG. 10. As manifest in the figure, the image on the cross-section j-j has a pattern similar to that of a conventional bar code, e.g., consisting of dark strips 17 and blank portions 18.

FIG. 12 is a schematic diagram of optical mechanisms for dispersing and distorting incident light rays emitted from a light source. It is appreciated that while FIGS. 8 and 9 are schematic cross-sectional view of the O-A sheet 60 cut along the length (the Y-coordinate) thereof, FIG. 12 is the schematic cross-sectional view of the O-A sheet 60 sliced along the width (the X-coordinate) thereof It is further noted that while the O-A agents 50 in FIGS. 8 and 9 include protrusions 53 extending along the length of the O-A sheet 60, the O-A agent 50 in FIG. 12 is provided with protrusions 54 extending along the width of the O-A sheet 60.

The light source 22 projects the incident light rays 44 onto the glass window 41. Although the incident light rays 44 are drawn parallel to each other in the X-coordinate, it is noted that the incident light rays 44 may form an incident angle other than 90° in the direction of the height (Y-coordinate) of the O-A sheet. 60 so that the incident light rays 44 do not strike the glass window 41 vertically. The incident light rays 44 are then refracted at the interface 47a, transmitted through the glass window 41, refracted at the interface 47e, and projected onto the O-A sheet 60. Because of the surface structure and intrinsic optical properties of the O-A agent 50, the O-A sheet 60 disperses and/or distorts the reflected incident light rays 44 and, therefore, the light collector 48 such as a printing drum or a CCD array is stricken with the second light rays 49 generally not parallel to each other and having a distorted distribution pattern which is different from a regular distribution pattern of the first light rays 45 (see FIGS. 4 and 5).

As illustrated in FIGS. 6 through 12, the O-A agent 50 is capable of dispersing or distorting light rays projected thereon by various optical mechanisms such as reflection, refraction, diffraction, and transmission. Due to such O-A agent 50 attached thereon, the O-A sheet 60 almost always diminishes the amount of light rays striking the mirror 46 or the light collector 48. Extent of such dispersion and/or distortion can be quantitatively assessed by employing a “distortion ratio” which is defined as the ratio of the second intensity of the second light rays 49 to the first intensity of the first light rays 45. The first intensity of the first light rays 45 is measured by projecting, upon the image on the plain sheet 10, the incident light rays 44 emitted from a light source 42 located at a first distance and at a source incident angle with respect to the plain sheet 10, and then by measuring the amount of the first light rays 45 which emanate from the plain sheet 10 and which are projected upon the light collector 48 that is fixed at a given measurement location. The second intensity of the second light rays 49 is similarly measured by projecting, upon the same image on the plain sheet 10, the same incident light rays 44 emitted from the same light source 42 at the same first distance and at the same source incident angle with respect to the same image on the plain sheet 10 and by measuring the amount of the second light rays 49 which emanate from the same image in the O-A 60 and which are projected upon the same light collector 48 that is fixed at the same measurement location. Because of the dispersion or distortion caused by the O-A agent 50, the distortion ratio of the O-A sheet 60 is almost always less than 1.0. In addition, as the O-A sheet 60 disperses or distorts more light rays projected thereupon, the distortion ratio decreases to a smaller number. Details regarding the surface structure or inherent properties of the O-A agent 50 pertaining to these aspects of the present invention will be below provided in conjunction with FIG. 13.

It is appreciated that the O-A agent 50 (and the resulting O-A sheet 60) may be shaped, sized, and/or arranged to have a specific value or range of the above-described distortion ratio. For example, the surface structure of the O-A agent 50, the intrinsic properties thereof, two- or three-dimensonal arrangement thereof, and/or process of attaching the O-A agent 50 on the plain sheet 10 may be precisely manipulated to obtain the O-A sheet 60 having the distortion ratio ranging from 0.999 to 0.001 by increment of, e.g., 0.05. It is also appreciated, however, that the O-A agent 50 or the resulting O-A sheet 60 may have an inherent practical minimum value or range of the distortion ratio. For example, the distortion ratio less than, e.g., 0.1 or 0.01 may disperse or distort too much of the light rays so that the original images on the O-A sheet 60 will not be visible any more, not to mention a reproduced copy or scanned thereof.

Similarly, the O-A sheet 60 may also be arranged such that the difference between a regular distribution pattern of the first light rays 45 and a distorted distribution pattern of the second light rays 49 may be maximized or minimized at a specific value or a range of incident and/or projection angles. As described above, the differences in distribution patterns depend upon several factors such as a source incident angle of the incident light rays 44 emitted by the light source 22 toward the image on the plain sheet 10, a first projection angle of the first light rays 45 emanating from the plain sheet 10, a second projection angle of the second light rays 49 emanating from the O-A agent 50 or the O-A sheet 60, a first distance between the light source 22 and the image, and/or a second distance between the image and the light collector 48. Therefore, the surface structure or inherent properties of the O-A agent 50, may be manipulated so that the difference between the distribution patterns may reach a maximum value when one or more of the incident or projection angles reach a certain threshold value, e.g., any angle between 15° and 90° with respect to the glass window 41 and/or angles such as 15°, 30°, 45°, 60°, 75°, 85° or 90° with respect to the plain sheet. In the alternative, such differences may also be arranged to reach a maximum value when at least one of the first and second distances is less than a certain value, e.g., 3 feet, 2 feet, 1 foot, 9 inches, 7 inches, 5 inches, 4 inches, 3 inches, 2 inches, one inch or less. Details regarding the surface structure or inherent properties of the O-A agent 50 pertaining to this aspect of the invention will be provided below in conjunction with FIG. 13.

The O-A agent may be composed of various materials capable of dispersing or distorting paths of light rays projected thereon by, e.g., reflection, refraction, diffraction or transmission. These materials may be transparent, translucent, semi-transparent, and even opaque. In addition, the surface or interior of these materials may include virtually any types of structure as long as any of the above-described optical mechanisms may exist thereby. Furthermore, these materials may be provided in the form of solid, gels, paste, powder, particulate, and even solution or emulsion. If the non-solid material is used as the O-A agent, it is preferred that the O-A agent be attached to the plain sheet by processes capable of converting the non-solid O-A agent into solid thereof. It is appreciated that the chemical and/or mechanical properties of the materials may not be critical in selecting the O-A agent or the O-A sheet and, therefore, it is generally a matter of selection by one of those skilled in the art to choose appropriate materials for the O-A agent or the O-A sheet based substantially on the optical properties thereof. However, it is preferred that the materials for the O-A agent have thermal properties such that they maintain their surface and/or interior structure during the process of lamination or other attaching processes known in the art. Examples of such materials may include, but not limited to, polymers, metals, and minerals.

Examples of polymeric O-A agents may include, but not limited to, homogeneous-, blend- or co-polymers of styrene, ethylene, propylene, butadiene, acrylate, vinyl chloride, urethane, carbonate, acetate, ester, cellulose, terephthalate, methyl-methacrylate, sulfone, amide, isoprene, glycol, ether, epoxy, acrylic, arylene, dienes, olefins, alpha-olefins, poly-olefins, phenylene oxide, cyclo-pentadiene, cyanoprene, and vinyl-toluene. In addition, rubbers, resins or other elastomers such as natural rubber, butyl rubber, chlorinated butyl rubber, poly-butadiene rubber, styrene rubber, acrylonitrile-butadiene rubber, ABS, poly-chloroprene may be used as the O-A agent. In addition, substituted forms of the above-described polymers may also be used where one or more atoms may be replaced by one or more molecules such as chlorine, and oxygen, and/or by one or more groups such as methyl-, ethyl-, propyl-, isopropyl-, vinyl-, acrylic, and phenyl. Furthermore, any mixture of the above-mentioned material as well as any other heat-sealable materials may also be employed. Examples of metallic and/or non-metallic agents may include, but not limited to, aluminum, zinc, magnesium, copper, nickel, lead, tungsten, silver, gold, iron, stainless steel, calcium, silicon, quartz, silica, germanium, and their mixtures, oxides or compounds. In addition, the O-A agent may include or be made of any fluorescent or crystalline materials such as liquid crystal.

The O-A agent as well as the resulting O-A sheet utilizes optical properties thereof to disperse the light rays projected thereupon and/or distort the paths as well as the light distribution pattern thereof. In general, the light rays are dispersed and/or distorted by various mechanisms including, but not limited to, reflection, refraction, diffraction, and/or transmission. Thereby, the O-A agent may change brightness or color of a portion of the image into that of a background or vice versa, may obscure or alter the difference in brightness or color between the image and background, may distort brightness or color of a portion of the background and/or the image, and/or may distort a shape, size or configuration of a portion of the image and/or background. In addition, the O-A sheet may also block a portion of the incident light rays emitted by a light source toward the image, block a portion of the first and/or the second light rays, distorting a portion of any of the above light rays, and/or adding to the above light rays other light rays not having a comparable incident angle and/or not originating from the light source at the same location. The O-A agent may also block the light rays. e.g., by absorbing a portion of any of the above light rays, and deflecting the portion of the above light rays in, e.g., another direction in which the rest of the light rays travel. The O-A agent may also be able to mis-align a portion of any of the above light rays, and to deflect a portion of any of the above light rays in one direction which is slightly different from another direction along which the rest of the rays travel. In the alternative, the O-A agent may adjust an extent of the distortion according to a source incident angle of incident light rays emitted by a light source toward the image, a first projection angle of the first light rays, and/or a second projection angle of the second light rays. Alternatively, the O-A agent may also adjust the extent of distortion thereby depending on a first distance between a light source and the image on the plain sheet and/or a second distance between such image and a reproduction device. Detailed embodiments of the O-A agent will now be provided in conjunction with FIG. 13.

FIG. 13 is a schematic diagram of several exemplary embodiments of the solid O-A agent according to the present invention. Although FIG. 13 pertains to a film-type O-A agent 50, it is appreciated that the similar surface structure may be provided to non-film-type O-A agent 50 and that even a non-solid O-A agent 50 may form the similar surface structure after being attached to the plain sheet 10 and being solidified thereon. The O-A agent 50 may include protrusions 55a, 55b, 55c on either and/or both of its surfaces. The protrusions 55a, 55c may be arranged to extend across the entire length or width of the O-A agent 50 or to form non-continuous surface structures 55b. The O-A agent 50 may also include multiple grooves 56a, 56b, 56c on either and/or both surfaces thereof. The grooves 56a, 56b may also be arranged to extend across the entire length or width of the O-A agent 50 or to form non-continuous surface structures 56c. Height, depth, cross-sectional shapes of the protrusions 55a, 55b, 55c and the grooves 56a, 56b, 56c may vary according to the preferred distortion ratio or the difference between the light distribution patterns. In general, higher protrusions 55a, 55b, 55c and deeper grooves 56a, 56b, 56c provide less distortion ratio and prominent difference between the light distribution patterns. The O-A agent 50 may also include multiple openings or apertures 57 provided across the thickness thereof, composite patches 58 having heterogeneous optical properties and thereby causing heterogeneous optical mechanisms across the surface of the O-A agent 50, and/or by-pass optical pathways 59 such as optical fibers provided inside the O-A agent 50 and through which light rays travel along the length or width of the O-A agent 50. The optical pathways 59 may also be arranged to have a cross-sectional shape capable of inducing irregular refraction of the light rays emitted thereto or emanated thereby.

It is appreciated that the above described surface and/or interior structures may be distributed evenly or unevenly across the O-A agent 50 and that uneven distribution of the surface structure is generally more effective in distorting the image provided on the plain sheet 10. It is also appreciated that different features may have to be provided to the O-A agent 50 depending on which optical mechanism plays a major role in such dispersion or distortion of the light rays. For example, where the light rays are distorted predominantly by light reflection, the surface characteristics of the O-A agent becomes the most important factor. Similarly, transmittivity becomes important for a transparent O-A agent 50, for internal transmission of light rays may become important than in an opaque O-A agent 50. It is further appreciated that the O-A agent 50 may be provided as a solid article such as a sheet, film, screen, mesh, net, string, and/or wire. These solid articles may be provided as individual sheet having a shape and size attachable to the plain sheet 10 or in a roll from which an appropriate length of a sheet may be cut off. In the alternative, the O-A agent 50 may also be provided as a non-continuous solid article such as a bead, flake, shrapnel, rod, cone, cylinder, sphere, hemisphere, powder, and/or particulate. These O-A agents 50 may be arranged to be delivered onto the surface of the plain sheet 10 by conventional spray method, by applying electric or electro-static attractive force or by other appropriate delivery methods known in the art. The O-A agent 50 may further be provided in a non-solid phase such as gel, paste, gum, aerosol, spray, solution, and/or emulsion. These O-A agents 50 may be arranged to be sprayed onto or to wet the surface of the plain sheet 10. By removing water or solvent by, e.g., drying, the O-A agent 50 is arranged to form a solid structure on the plain sheet 10.

In another aspect of the invention, a sheet-making device is provided to produce the O-A sheet 60 by attaching the O-A agent 50 onto the plain sheet 10 and converting the plain sheet 10 into the O-A sheet 60 having thereon a continuous or discrete layer of the O-A agent 50. FIG. 14 is a schematic diagram of an exemplary sheet-making device according to the present invention. As illustrated in the top portion of the figure, the sheet-making device 70 includes therein a conventional photo-copying machine. The plain sheet 10 is stored in a paper supply 71 located under the printing drum 28. A feed mechanism (not shown) picks up a single plain sheet 10 from the paper supply 71 and delivers it toward the printing drum 28 through rollers 72a, 72b. The images reproduced by the printing drum 28 is transferred on the plain sheet 10, toner powder is sealed onto the plain sheet 10, and the (printed) plain sheet 10 is transported to an interposing roller 74a installed at an entrance of an attaching unit 74. The O-A agent 50 is also provided as sheet having shape and size matching those of the plain sheet 10, and stored in an agent supply 73. Another feed mechanism (not shown) picks up a single sheet of the O-A agent 50 and delivers it through a pair of rollers 73a toward the interposing roller 74a. The interposing roller 74a takes up both the O-A agent 50 and the printed plain sheet 10, while pressing the O-A agent 50 onto the image-bearing surface of the plain sheet 10. Rollers 74a feed the composite sheet into the attaching unit 74 in which the O-A agent 50 is attached to the plain sheet 10, preferably by forming a non-peelable bonding therebetween. The O-A sheet 60 is removed from the attaching unit 74 and dispensed through a dispenser unit such as rollers 74b.

It is appreciated that the attaching unit 74 may be provided with a control feature such that an amount or a thickness of the O-A agent attached on the plain sheet 10 may vary according to the needs. For example, a thicker layer or multiple layers of the O-A agent may be placed on, e.g., densely printed areas of the plain sheet 10. Alternatively, when using the non-film-type O-A agent, the attaching unit 74 may apply a greater amount of the O-A agent may be applied on such area of the plain sheet 10.

It is appreciated that the attaching unit 74 may use various methods to attach the O-A agent 50 onto the plain sheet 10. One example is a thermal laminating where the O-A agent 50 is heated and pressed onto the image-bearing surface of the plain sheet 10. Another example is a conventional bonding where an adhesive or a layer thereof is provided between the O-A agent 50 and the plain sheet 10, and dried or cured, e.g., by UV rays, to form a bonding therebetween. The O-A agent 50 may also be physically or chemically converted during the attaching processes. Other conventional adhesion method may also be employed.

It is also appreciated that the sheet-making device of FIG. 14 may be installed in any conventional reproduction devices. Examples of these reproduction device may include, but not limited to, a copy machine, scanner, facsimile, devices using CCD (charge-coupled device), OCR (optical character recognition device), acoustic-wave imaging device, and/or any other electromagnetic wave imaging device.

It is further appreciated that the sheet-making device of FIG. 14 may alternatively be provided as an add-on module (not shown) for the above-mentioned reproduction devices. For example, such attachable sheet-making device may include a receiver for receiving the printed plain sheet from the reproduction device, a storage unit for storing the O-A agent, a delivery unit for delivering the O-A from the storage unit to the printed plain sheet, an attaching unit capable of attaching the O-A agent onto the image-bearing surface of the plain sheet, and a coupling unit for coupling the sheet-making module to the reproduction device. This embodiment offers the benefit of converting the printed plain sheet from conventional reproduction devices into the O-A sheet which is capable of distorting a distribution pattern of light rays representing the image.

It is to be understood that, while various embodiments of the present invention has been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

1. An optically active sheet comprising:
a plain sheet having an image provided thereon and capable of emanating first light rays having a regular distribution pattern representing said image; and
an optically active agent attached onto at least a portion of said plain sheet,
wherein said optically active agent is capable of distorting paths of light rays projected thereupon and wherein said optically active sheet is capable of emanating second light rays having a distorted distribution pattern of said image which is different from said regular distribution pattern representing said image.

2. The optically active sheet according to claim 1 wherein said plain sheet and said optically active agent form non-peelable bonding therebetween.

3. The optically active sheet according to claim 1 wherein a difference between said regular distribution pattern and said distorted distribution pattern depends on a factor comprising at least one of a source incident angle of incident light rays emitted by a light source toward said image, a first projection angle of said first light rays emanating from said plain sheet, a second projection angle of said second light rays emanating from said O-A sheet, a first distance between said light source and said image on said plain sheet, and a second distance between said image and a reproduction device.

4. The optically active sheet according to claim 3 wherein said difference between said distribution patterns reaches a maximum thereof when at least one of the incident and the projection angles is greater than 30°.

5. The optically active sheet according to claim 3 wherein said difference between said distribution patterns reaches a maximum thereof when at least one of the incident and the projection angles is greater than 45°.

6. The optically active sheet according to claim 3 wherein said difference between said distribution patterns reaches a maximum thereof when at least one of the incident and the projection angles is greater than 60°.

7. The optically active sheet according to claim 3 wherein said difference between said distribution patterns reaches a maximum thereof when at least one of the incident and the projection angles is greater than 75°.

8. The optically active sheet according to claim 3 wherein said difference between said distribution patterns reaches a maximum thereof when at least one of the distances is less than 3 feet.

9. The optically active sheet according to claim 3 wherein said difference between said distribution patterns reaches a maximum thereof when at least one of the distances is less than 5 inches.

10. The optically active sheet according to claim 3 wherein said difference between said distribution patterns reaches a maximum thereof when at least one of the distances is less than 3 inches.

11. The optically active sheet according to claim 3 wherein said difference between said distribution patterns reaches a maximum thereof when at least one of the distances is less than an inch.

12. The optically active sheet according to claim 1 wherein said second light rays emanating from said optically active sheet is configured to have a distortion ratio which is less than 1.0, said distortion ratio defined as a ratio of a second intensity of said second light rays to a first intensity of said first light rays,
wherein said first intensity of said first light rays is measured by projecting incident light rays onto said image on said plain sheet from a light source located at a first distance and at a source incident angle with respect to said image and by measuring an amount of said first light rays projected upon a collector fixed at a measurement location and wherein said second intensity of said second light rays is measured by projecting the incident light rays onto said image on said plain sheet from the light source located at the first distance and at the source incident angle with respect to said image and by measuring an amount of said second light rays projected upon the collector fixed at the measurement location.

13. The optically active sheet according to claim 12 wherein said distortion ratio is less than 0.9.

14. The optically active sheet according to claim 12 wherein said distortion ratio is less than 0.7.

15. The optically active sheet according to claim 12 wherein said distortion ratio is less than 0.5.

16. The optically active sheet according to claim 12 wherein said distortion ratio is less than 0.3.

17. The optically active sheet according to claim 12 wherein said distortion ratio is greater than 0.1.

18. The optically active sheet according to claim 1 wherein said optically active sheet is capable of emanating at least a portion of said second light rays at a second projection angle that is different from a first projection angle at which said plain sheet emanates a significant portion of said first light rays.

19. The optically active sheet according to claim 1 wherein said optically active agent is configured to have a continuous solid structure comprising at least one of a sheet, film, screen, mesh, net, string, and wire.

20. The optically active sheet according to claim 19 wherein said optically active agent is configured to have an upper flat surface and a lower non-flat surface.
